(19) United States
(12) Patent Application Publication
(10) Pub. No.: US 2025/0145408 A1
(43) Pub. Date: May 8, 2025

(54) CONSTRUCTION TIME USE OF ELEVATORS

(71) Applicant: KONE Corporation, Helsinki (FI)

(72) Inventors: Janne Öfversten, Helsinki (FI); Tommi Loukas, Helsinki (FI); Jussi-Pekka Partanen, Helsinki (FI); Ville Piirainen, Helsinki (FI); Jaakko Ranne, Helsinki (FI)

(73) Assignee: KONE Corporation, Helsinki (FI)

(21) Appl. No.: 19/013,899

(22) Filed: Jan. 8, 2025

Related U.S. Application Data
(63) Continuation of application No. PCT/EP2022/073452, filed on Aug. 23, 2022.

(51) Int. Cl. B66B 1/24; B66B 13/14

(52) U.S. Cl. CPC B66B 1/2408; B66B 13/143; B66B 2201/4661

(57) ABSTRACT

According to an aspect, there is provided a method and a system for construction time use of at least one elevator car of an elevator system. A hauling call may be generated for at least one transportable entity, the hauling call defining a departure floor and a destination floor. An extended door time may be set for the departure floor and the destination floor. The hauling call may be allocated to an elevator car, and other calls may be prevented from being allocated to the elevator car simultaneously with the hauling call between the departure floor and the destination floor.

### BACKGROUND

Elevators may be used in a building construction phase and traffic profiles of the elevators may change daily. In the constructions phase, the elevators are used primarily for construction material and equipment transport. In the construction time use (CTU), the elevators may be very heavily used and waiting times may increase. In the CTU, the amount construction material and equipment transported with the elevators may be significant, and loading and unloading the of transported construction material and equipment may take some time.

Therefore, it is important the construction time use of the elevators is implemented efficiently.

### SUMMARY

According to a first aspect, there is provided a method for construction time use of at least one elevator car of an elevator system. The method comprises generating a hauling call for at least one transportable entity, the hauling call defining a departure floor and a destination floor; setting an extended door time for the departure floor and the destination floor; allocating the hauling call to an elevator car; and preventing other calls from being allocated to the elevator car simultaneously with the hauling call between the departure floor and the destination floor.

In an implementation form of the first aspect, the method further comprises obtaining priority information relating to the at least one transportable entity associated with the hauling call, each transportable entity being associated with a priority; and determining a priority for the hauling call based on the priorities of the at least one transportable entity.

In an implementation form of the first aspect, the method further comprises obtaining schedule information relating to the at least one transportable entity associated with the hauling call; and generating the hauling call based on the schedule information.

In an implementation form of the first aspect, the method further comprises obtaining first identification information relating to the at least one transportable entity associated with the hauling call, the first identification information comprising an identifier associated with each of the at least one transportable entity; obtaining second identification information relating to transportable entities loaded into the elevator car, the second identification information comprising an identifier associated with each of the at least one transportable entity loaded into the elevator car; comparing the first identification information with the second identification information; determining that loading of the elevator car in the departure floor is complete when the first identification information matches with the second identification information; and issuing a command to close doors at the departure floor when determining that loading of the elevator car in the departure floor is complete.

In an implementation form of the first aspect, the method further comprises obtaining third identification information relating to transportable entities unloaded from the elevator car, the third identification information comprising an identifier associated with each of the at least one transportable entity unloaded from the elevator car; comparing the second identification information with the third identification information; determining that unloading of the elevator car in the destination floor is complete when the second identification information matches with the third identification information; and issuing a command to close doors at the destination floor when determining that unloading of the elevator car in the destination floor is complete.

In an implementation form of the first aspect, the method further comprises obtaining information that the elevator car is empty at the destination floor; and issuing a command to close doors at the destination floor in response to obtaining information that the elevator car is empty at the destination floor.

In an implementation form of the first aspect, the method further comprises obtaining, from a user device, information associated with the extended door time for the departure floor and/or the destination floor; and setting the extended door time for the departure floor and/or the destination floor based on the information.

In an implementation form of the first aspect, the method further comprises obtaining a door closing command associated with the departure floor or the destination floor from a user device; and issuing a command to close doors at the departure floor or the destination floor in response to the door closing command.

According to a second aspect, there is provided a system for construction time use of at least one elevator car of an elevator system. The system comprises means for generating a hauling call for at least one transportable entity, the hauling call defining a departure floor and a destination floor; means for setting an extended door time for the departure floor and the destination floor; means for allocating the hauling call to an elevator car; and means for preventing other calls from being allocated to the elevator car simultaneously with the hauling call between the departure floor and the destination floor.

In an implementation form of the second aspect, the system further comprises means for obtaining priority information relating to the at least one transportable with hauling call, each entity associated the transportable entity being associated with a priority; and means for determining a priority for the hauling call based on the priorities of the at least one transportable entity.

In an implementation form of the second aspect, the system further comprises means for obtaining schedule information relating to the at least one transportable entity associated with the hauling call; and means for generating the hauling call based on the schedule information.

In an implementation form of the second aspect, the system further comprises means for obtaining first identification information relating to the at least one transportable entity associated with the hauling call, the first identification information comprising an identifier associated with each of the at least one transportable entity; means for obtaining second identification information relating to transportable entities loaded into the elevator car, the second identification information comprising an identifier associated with each of the at least one transportable entity loaded into the elevator car; means for comparing the first identification information with the second identification information; means for determining that loading of the elevator car in the departure floor is complete when the first identification information matches with the second identification information; and means for issuing a command to close doors at the departure floor when determining that loading of the elevator car in the departure floor is complete.

In an implementation form of the second aspect, the system further comprises means for obtaining third identification information relating to transportable entities unloaded from the elevator car, the third identification information comprising an identifier associated with each of the at least one transportable entity unloaded from the elevator car; means for comparing the second identification information with the third identification information; means for determining that unloading of the elevator car in the destination floor is complete when the second identification information matches with the third identification information; and means for issuing a command to close doors at the destination floor when determining that unloading of the elevator car in the destination floor is complete.

In an implementation form of the second aspect, the system further comprises means for obtaining information that the elevator car is empty at the destination floor; and means for issuing a command to close doors at the destination floor in response to obtaining information that the elevator car is empty at the destination floor.

In an implementation form of the second aspect, the system further comprises means for obtaining, from a user device, information associated with the extended door time for the departure floor and/or the destination floor; and means for setting the extended door time for the departure floor and/or the destination floor based on the information.

In an implementation form of the second aspect, the system further comprises means for obtaining a door closing command associated with the departure floor or the destination floor from a user device; and means for issuing a command to close doors at the departure floor or the destination floor in response to the door closing command.

According to a third aspect, there is provided an elevator system comprising the system of the second aspect.

According to a fourth aspect, there is provided a computer program comprising instructions stored thereon for performing the method of the first aspect.

According to a fifth aspect, there is provided a computer-readable medium comprising a computer program comprising instructions stored thereon for performing the method of the first aspect.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a flow diagram of a method according to an example embodiment.

FIG. 2 illustrates a block diagram of an apparatus according to an example embodiment.

FIG. 3 illustrates a system according to an example embodiment.

### DETAILED DESCRIPTION

Various examples and embodiments discussed herein disclose a solution in which an apparatus, for example, a site controller for construction site use (CTU), may be arranged in an elevator system.

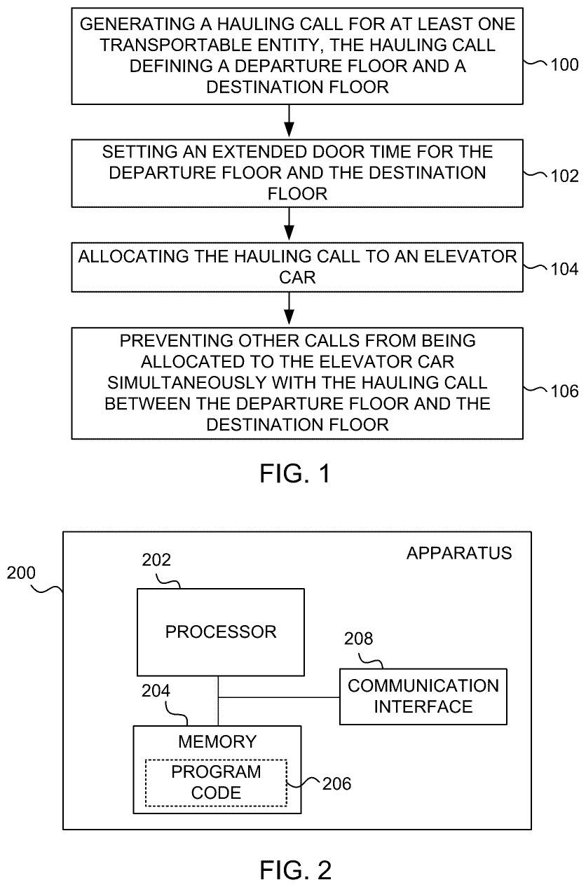

FIG. 1 illustrates a flow chart of a method for construction time use of at least one elevator car of an elevator system according to an example embodiment. The method may be implemented by the apparatus, for example, the t site controller. In another example embodiment, the method may be implemented so that one or more steps may be implemented by the site controller and one or more steps may be implemented by at least one other entity, for example, an elevator controller or an elevator group controller.

At 100 a hauling call may be generated for at least one transportable entity, the hauling call defining a departure floor and a destination floor. The hauling call may refer to a call or a load call during which construction materials and tools may be various transported between the departure floor and the destination floor. A transportable entity may refer, for example, to at least one of a material, a tool, a batch of material, a person etc. Further, one or more properties may be associated with a transportable entity and may be known beforehand, for example, a weight, dimensions, a priority, a time window when the transportable entity is needed at a specific location, a destination floor, an identifier etc. The hauling call may be generated, for example, by a site controller discussed in more detail below.

At 102 an extended door time may be set for the departure floor and the destination floor. As the hauling call is configured to transport the at least one transportable entity, loading and unloading of the at least one transportable entity may take some time. Therefore, the extended door time may be set for the departure floor and the destination floor, for example, manually when the hauling call is generated or automatically, for example, to a default value or to a value determined based on the at least one transportable entity. The extended door time may be set, for example, by the site controller discussed in more detail below.

At 104 the hauling call may be allocated to an elevator car. The hauling call allocation may be implemented, for example, by an elevator controller or an elevator group controller. In an example embodiment, the site controller may send the hauling call to the elevator controller or the elevator group controller.

At 106 other calls may be prevented from being allocated to the elevator car simultaneously with the hauling call between the departure floor and the destination floor. The solution discussed above may enable a hauling mode that provides an optimized configuration for logistic purposes. Further, there is no need to block any door with a physical object. The prevention of other calls may be implemented, for example, by the elevator controller or the elevator group controller.

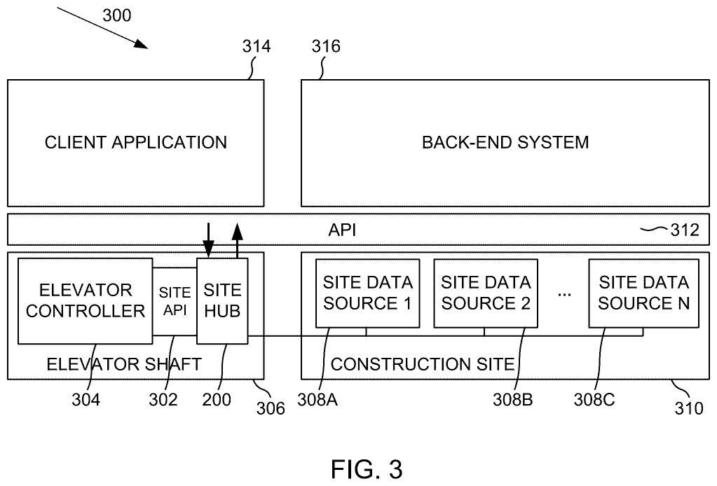

FIG. 2 illustrates a block diagram of an apparatus 200 according to an example embodiment. The apparatus 200 may be, for example, a computer or a server computer, and it may be configured to implement the functions performed by a site controller. In an example embodiment, the apparatus 200 may be integrated to be part of an elevator controller, an elevator group controller or an elevator drive as a separate circuit board/module or as an integrated hardware. In another example embodiment, the apparatus 200 may be implemented, for example, with an additional software in the elevator controller, elevator group module controller or elevator drive. In other words, the apparatus 200 may refer, for example, to an elevator controller, an elevator group controller or an elevator drive that is configured to implement the discussed features. The apparatus may be configured to implement one or more of the features and/or steps discussed in the description of FIG. 1 and FIG. 3.

The apparatus 200 comprises one or more processors 202, and one or more memories 204 that comprise computer program code. The apparatus 200 may also include at least one software and/or hardware communication interface 208 for communicating with one or more other entities. Although the apparatus 200 is depicted to include only one processor 202, the apparatus 200 may include more than one processor. In an example embodiment, the memory 204 is capable of storing instructions, such as an operating system and/or various applications.

Furthermore, the processor 202 is capable of executing the stored instructions. In an example embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 202 may be configured to execute hard-coded functionality. In an example embodiment, the processor 202 is embodied as an executor of software instructions, wherein the instructions may specifically configure the processor 202 to perform the algorithms and/or operations described herein when the instructions are executed.

The memory 204 may be embodied as one or more volatile memory devices, one or more non-volatile memory devices, and/or a combination of one or more volatile memory devices and non-volatile memory devices. For example, the memory 204 may be embodied as semiconductor memories (such as mask ROM, PROM (programmable ROM), EPROM (erasable PROM), flash ROM, RAM (random access memory), etc.).

In an embodiment, the at least one memory 204 may store program instructions 206 that, when executed by the at least one processor 202, cause the apparatus 200 to perform the functionality of the various embodiments discussed herein. Further, in an embodiment, at least one of the processor 202 and the memory 204 may constitute means for implementing the discussed functionality.

FIG. 3 illustrates a system 300 according to an example embodiment. The system 300 illustrated in FIG. 3 may be applied, for example, during a construction time use (CTU). In the CTU, one or more elevators may be timely used to transport various materials and/or tools and also personnel from a departure floor to a destination floor. The system 300 may comprise means for generating a hauling call for at least one transportable entity, the hauling call defining a departure floor and a destination floor, means for setting an extended door time for the departure floor and the destination floor, means for allocating the hauling call to an elevator car, and means for preventing other calls from being allocated to the elevator car simultaneously with the hauling call between the departure floor and the destination floor. One or more entities of the system 300, for example, a site controller 200, an elevator controller 304 and/or an elevator group controller, may be used to implement the features/steps discussed earlier in relation to FIG. 1 and the features/steps discussed herein and may thus constitute means for implementing the discussed functionality.

The system comprises a site controller 200 (or a site hub) which may be connected to an elevator controller 304 via a site application programming interface (API) 302. In another example embodiment, the functions of the site controller 200 may be implemented by the elevator controller 304 and thus no API 302 and separate site controller 200 are needed. In an example embodiment the site controller 200 and the elevator controller 304 may be arranged in an elevator shaft 306. The site controller 200 in general may refer to an entity that is configured to enable an access or a connection to a variety of different system elements. In an example embodiment, the site controller 200 may be integrated to be part of an elevator controller, an elevator group controller or an elevator drive as a separate circuit board/module or as an integrated hardware. In another example embodiment, the site controller 200 may be implemented, for example, with an additional software module in the elevator controller, elevator group controller or elevator drive. In other words, the site controller 200 may refer, for example, to an elevator controller, an elevator group controller or an elevator drive that is configured to implement the discussed features.

The site controller 200 may comprise a first communication interface configured to provide a connection to at least one local construction site data source 308A, 308B, 308C associated with a construction site 310, wherein the at least one local construction site data source is configured to track people and/or material flow during the construction time use. The connection to the at least one local construction site data source 308A, 308B, 308C may be implemented, for example, using at least one the following techniques: a Wi-Fi connection, a physical Ethernet connection or an IoT mesh connection depending on the location. The Wi-Fi connection may be used, for example, when high data throughput is needed. The IoT mesh connection may be used, for example, for small, cheap and/or battery powered devices that do not send much data.

In general, the at least one local construction site data source 308A, 308B, 308C may refer to external sensors, automated systems and/or data sources that provide information about which tools, materials and people are about to be, or are currently being transported in the elevator. Different site data may be arranged in a single data source, for example, a database, or in multiple data sources. Any appropriate tracking and/or identification system may be used to track and/or identify the tools, material and people, for example, Bluetooth, radio frequency identification (RFID) applying RFID tags, wireless positioning etc. The local construction site data source 308A, 308B, 308C and/or back-end systems 316 may comprise identification information associated with each transportable entity. The identification information may be stored, for example, in a remotely readable device or tag, for example, a radio frequency identification (RFID) tag, attached to or otherwise associated with a transportable entity. The construction site may then comprise one or more readers that are able to remotely read the when the corresponding identification information, transportable entity is loaded/unloaded to/from an elevator. The readers may be arranged in the elevators or outside the elevators at appropriate locations.

In an example embodiment, the at least one local construction site data source 308A, 308B, 308C may comprise one or more of the following:
a material and waste tracking system
a people location and identification system
an asset location and usage rate management system
a site condition monitoring system.

The material and waste tracking system may provide information, for example, where material and/or tools are being located, and how much waste is accumulated during the construction phase. The people location and identification system may provide information, for example, on personnel location and identity of the personnel at the location. The asset location and usage rate management system may provide information, for example, on one or more assets that can be used in the construction site and their associated location. An asset may refer, for example, to a material, a tool, an employee etc. The asset location and usage rate management system may also track usage rate of the one or more assets, for example, when, where and/or how long an asset was used during the construction phase, where and/or how long a specific employee has worked in the constructions site during the construction phase etc. This may then provide management information, for example, to a back-end system 316. The site condition monitoring system may provide information, for example, on a status associated with the construction site. The status may refer, for example, to a degree of readiness of the construction site, safety and health issues (for example, the number of reported accidents, the number of accident-free days), temperature, humidity, particulate matter levels etc.

The site controller may further comprise a second communication interface, for example, an application programming interface (API) 312, configured to provide a connection to at least one client application 314 configured to access data provided by the site controller and to at least one back-end system 316 configured to provide construction project data associated with a construction site. The second communication interface 312 enables the site controller 200 to connect to external systems and external systems or client to connect to the site controller 200. For example, elevator calls may be allocated from a mobile device of a person working at the site. Additionally or alternatively, an elevator call may be scheduled and allocated automatically, for example, by a cloud-based managing entity, for example, the back-end system 316. In general, the back-end system or systems 316 may refer to automated systems and data sources that provide information about costs and/or priority of different materials, tools and people to be transferred with the at least one elevator.

In an example embodiment, the local construction site data sources 308A, 308B, 308B and/or the back-end systems 316 may store information associated with one or more transportable entities. A transportable entity may refer, for example, to at least one of a material, a tool, a batch of material, a person etc. Further, one or more properties may be associated with a transportable entity and may be known beforehand, for example, a weight, dimensions, a priority, a time window when the transportable entity is needed at a specific location, a destination floor, an identifier etc. In other words, the local construction site data sources 308A, 308B, 308B and/or the back-end systems 316 may include any information that somehow characterizes a transportable entity. Then, based on the information stored in the site data sources 308A, 308B, 308B and/or the back-end systems 316, the site controller 200 may be able to optimize the use of the elevators during the CTU.

In an example embodiment, the client application 314 may be executed in a device, for example, a mobile device of a user. The client application 314 may be used, for example, to place elevator calls, track material, tools and/or people.

In an example embodiment, the back-end system 316 may refer to one or more external project planning systems from which data indicating where items should be going may be obtained. The project planning system may comprise, for example, a cloud based construction project planning tool providing APIs to read data to other systems.

In an example embodiment, the back-end system 316 may refer to one or more logistics systems to obtain identification information of different materials, for example, to cloud based systems for tracking material deliveries and supply lines. The logistics systems may provide APIs to access logistics information that can be used by the site controller 200 for decision making.

In an example embodiment, the back-end system 316 may refer to one or more tool rental systems to obtain information of what kind of tools are being used, how they are used, and for what work tasks they are used during the CTU. The tool rental systems may refer to cloud based systems providing APIs with tool rental information that can be used by the site controller 200 for decision making.

In an example embodiment, the site data source 308A, 308B, 308C and/or the back-end systems 316 may store priority information relating to at least one transportable entity associated with a hauling call. Different transportable entities may have different priorities. When generating the hauling call, the site controller 200 may obtain the priority information from the site data source 308A, 308B, 308C and/or the back-end systems 316 and determine a priority for the hauling call based on the priorities of the at least one transportable entity. For example, the priority of the hauling call may have the same priority as the highest priority of the at least one transportable entity associated with the hauling call. In other example embodiments, the priority of the hauling call may be calculated differently.

In an example embodiment, the back-end systems 316 may store schedule information relating to the at least one transportable entity associated with the hauling call. The schedule information may set, for example, a specific time or time window at/during which a transportable entity is needed at a specific destination floor. The site controller 200 may then generate the hauling call based on the schedule information. This may enable a solution in which transportation timing of various transportable entities may be optimized. Further, if a schedule of a transportable entity changes during the construction time, the changed schedule can be updated into the back-end systems 316, and the site controller 200 is able to take this into account.

In an example embodiment, the site data source 308A, 308B, 308C may comprise identification information associated with each transportable entity. In another example embodiment, the identification information may be stored in the back-end system 316. The identification information may be stored, for example, in a remotely readable device or tag, for example, a radio frequency identification (RFID) tag, attached to or otherwise associated with a transportable entity. The construction site may then comprise one or more readers that are able to remotely read the identification information, when the corresponding transportable entity is loaded/unloaded to/from an elevator. The readers may be arranged in the elevators or outside the elevators at appropriate locations. The site controller 200 may first obtain the identification information relating to the at least one transportable entity associated with the hauling call. In an example embodiment, the site controller 200 may store the identification information relating to the at least one transportable entity associated with the hauling call in a memory and obtain the information from the memory. In another example embodiment, the site controller 200 may obtain the information, for example, from the site data source 308A, 308B, 308C or the back-end system 316. When the at least one transportable entity is then loaded into an elevator car, the site controller 200 may be configurated to receive the read identification information relating to transportable entities loaded into the elevator car. Then by comparing with the site controller 200 the identification information relating to the at least one transportable entity associated with the hauling call with the identification information obtained from the readers, it is possible to determine that loading of the elevator car in the departure floor is complete when the identification information relating to the at least one transportable entity associated with the hauling call matches with the identification information obtained from the readers. In other words, it can be determined that all the needed transportable entities have been loaded into the elevator car. In an example embodiment, the site controller 200 may obtain the identification information directly from the readers when the elevator car is loaded. In another example embodiment, the site controller 200 may obtain the identification information from the site data source 308A, 308B, 308C or the back-end system 316. In response to the determination, the site controller 200 may issue a command to close doors at the departure floor. This enables an automatic determination of the extended door time at the departure floor without having to set it manually to an approximate value. This also ensures that all the transportable entities associated with the hauling call will be transported to the destination floor.

In an example embodiment, the site controller 200 may similarly obtain identification information relating to transportable entities unloaded from the elevator car, the identification information comprising an identifier associated with each of the at least one transportable entity unloaded from the elevator car. In an example embodiment, the site controller 200 may obtain the identification information directly from the readers when the elevator car is unloaded. In another example embodiment, the site controller 200 may obtain the identification information from the site data source 308A, 308B, 308C or the back-end system 316. Then by site comparing with the controller 200 the identification information obtained from the readers when the elevator car was loaded with the identification information obtained from the readers when the elevator car is unloaded, it is possible to determine that unloading of the elevator car in the destination floor is complete when the identification information obtained from the readers when the elevator car was loaded matches with the identification information obtained from the readers when the elevator car is unloaded. In an example embodiment, the site controller 200 may store the identification information obtained earlier by the readers when the elevator car was loaded in a memory and obtain the information from the memory. In another example embodiment, the site controller 200 may obtain the identification information obtained earlier from the readers when the elevator car was loaded, for example, from the site data source 308A, 308B, 308C or the back-end system 316. In response to the determination, the site controller 200 may issue a command to close doors at the destination floor. This enables an automatic determination of the extended door time at the destination floor without having to set it manually to an approximate value.

In an example embodiment, the site controller 200 may obtain information that the elevator car is empty at the destination floor and issue a command to close doors at the destination floor in response to obtaining information that the elevator car is empty at the destination floor. Thus, when the elevator car is determined to be empty, for example, based on information from a weighing device, this can be used as an indication that all the transportable entities have been unloaded from the elevator car and the doors can be closed. This enables another solution for an automatic determination of the extended door time at the destination floor without having to set it manually to an approximate value.

In an example embodiment, the site controller 200 may obtain information associated with the extended door time for the departure floor and/or the destination floor, for example, from a user device or other entity. The information may determine a specific value for the extended door time. The site controller 200 may then set the extended door time for the departure floor and/or the destination floor based on the information. This enables a solution that does not require any additional identification systems to identify the transportable entities loaded/unloaded to/from the elevator car. The information associated with the extended door time for the departure floor and/or the destination floor may be determined, for example, based on the amount of the transportable entities their properties (for example, dimension, weight etc.).

In an example embodiment, the site controller 200 may obtain a door closing command associated with the departure floor or the destination floor from a user device and issue a command to close doors at the departure floor or the destination floor in response to the door closing command. This enables a solution in which it is not necessary to determine and set any approximate value for the extended door time. Instead, a person loading the transportable entities into the elevator car may issue the door closed command with his/her mobile device, when loading/unloading of the transportable entities has been finished.

In any example embodiment discussed above, the hauling call may be generated manually with a device, for example, a computer or a mobile device used by a user. The user may set the departure floor and the destination floor for the hauling call. Further, the user may manually select at least one transportable entity for the hauling call, for example, from a list of available transportable entities. Alternatively, the at least one transportable entity for the hauling call may be generated automatically by a back end system entity and the user only approves the automatic generation. The user may also set a priority for the hauling call. Alternatively, the priority may be set by the back end system or may be automatically set based on the priorities of the at least one transportable entity. In an example embodiment, when the hauling call is being generated, the user may be given a proposal to use stairs in case the at least one transportable entity can be carried if it is determined that the use of stairs would provide a faster solution for transporting the at least one transportable entity. In another example embodiment, the hauling call may be generated automatically locally or by a back end system connected to the site controller 200.

At least one of the examples and embodiments disclosed above may enable a solution which optimized transportation of transportable entities during a construction time use.

Example embodiments may be implemented in software, hardware, application logic or a combination of software, hardware and application logic. The example embodiments can store information relating to various methods described herein. This information can be stored in one or more memories, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

The components of the example embodiments may include computer readable medium or memories for holding instructions programmed according to the teachings and for holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, means-plus-function clauses are intended to cover the structures described herein as performing the recited function and not only structural equivalents, but also equivalent structures.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. A method for construction time use of at least one elevator car of an elevator system, the method comprising:
generating a hauling call for at least one transportable entity, the hauling call defining a departure floor and a destination floor;
setting an extended door time for the departure floor and the destination floor;
allocating the hauling call to an elevator car; and
preventing other calls from being allocated to the elevator car simultaneously with the hauling call between the departure floor and the destination floor.

2. The method according to claim 1, further comprising:
obtaining priority information relating to the at least one transportable entity associated with the hauling call, each transportable entity being associated with a priority; and
determining a priority for the hauling call based on the priorities of the at least one transportable entity.

3. The method according to claim 1, further comprising:
obtaining schedule information relating to the at least one transportable entity associated with the hauling call; and
generating the hauling call based on the schedule information.

4. The method according to claim 1, further comprising:
obtaining first identification information relating to the at least one transportable entity associated with the hauling call, the first identification information comprising an identifier associated with each of the at least one transportable entity;
obtaining second identification information relating to transportable entities loaded into the elevator car, the second identification information comprising an identifier associated with each of the at least one transportable entity loaded into the elevator car;
comparing the first identification information with the second identification information;
determining that loading of the elevator car in the departure floor is complete when the first identification information matches with the second identification information; and
issuing a command to close doors at the departure floor when determining that loading of the elevator car in the departure floor is complete.

5. The method according to claim 4, further comprising:
obtaining third identification information relating to transportable entities unloaded from the elevator car, the third identification information comprising an identifier associated with each of the at least one transportable entity unloaded from the elevator car;
comparing the second identification information with the third identification information;
determining that unloading of the elevator car in the destination floor is complete when the second identification information matches with the third identification information; and
issuing a command to close doors at the destination floor when determining that unloading of the elevator car in the destination floor is complete.

6. The method according to claim 1, further comprising:
obtaining information that the elevator car is empty at the destination floor; and
issuing a command to close doors at the destination floor in response to obtaining information that the elevator car is empty at the destination floor.

7. The method according to claim 1, further comprising:
obtaining, from a user device, information associated with the extended door time for the departure floor and/or the destination floor; and
setting the extended door time for the departure floor and/or the destination floor based on the information.

8. The method according to claim 1, further comprising:
obtaining a door closing command associated with the departure floor or the destination floor from a user device; and
issuing a command to close doors at the departure floor or the destination floor in response to the door closing command.

9. A system for construction time use of at least one elevator car of an elevator system comprising, the system comprising:
means for generating a hauling call for at least one transportable entity, the hauling call defining a departure floor and a destination floor;
means for setting an extended door time for the departure floor and the destination floor;
means for allocating the hauling call to an elevator car; and
means for preventing other calls from being allocated to the elevator car simultaneously with the hauling call between the departure floor and the destination floor.

10. The system according to claim 9, further comprising:
means for obtaining priority information relating to the at least one transportable entity associated with the hauling call, each transportable entity being associated with a priority; and
means for determining a priority for the hauling call based on the priorities of the at least one transportable entity.

11. The system according to claim 9, further comprising:
means for obtaining schedule information relating to the at least one transportable entity associated with the hauling call; and
means for generating the hauling call based on the schedule information.

12. The system according to claim 9, further comprising:
means for obtaining first identification information relating to the at least one transportable entity associated with the hauling call, the first identification information comprising an identifier associated with each of the at least one transportable entity;
means for obtaining second identification information relating to transportable entities loaded into the elevator car, the second identification information comprising an identifier associated with each of the at least one transportable entity loaded into the elevator car;
means for comparing the first identification information with the second identification information;
means for determining that loading of the elevator car in the departure floor is complete when the first identification information matches with the second identification information; and
means for issuing a command to close doors at the departure floor when determining that loading of the elevator car in the departure floor is complete.

13. The system according to claim 12, further comprising:
means for obtaining third identification information relating to transportable entities unloaded from the elevator car, the third identification information comprising an identifier associated with each of the at least one transportable entity unloaded from the elevator car;
means for comparing the second identification information with the third identification information;
means for determining that unloading of the elevator car in the destination floor is complete when the second identification information matches with the third identification information; and
means for issuing a command to close doors at the destination floor when determining that unloading of the elevator car in the destination floor is complete.

14. The system according to claim 9, further comprising:
means for obtaining information that the elevator car is empty at the destination floor; and
means for issuing a command to close doors at the destination floor in response to obtaining information that the elevator car is empty at the destination floor.

15. The system according to claim 9, further comprising:
means for obtaining, from a user device, information associated with the extended door time for the departure floor and/or the destination floor; and
means for setting the extended door time for the departure floor and/or the destination floor based on the information.

16. The system according to claim 9, further comprising:
means for obtaining a door closing command associated with the departure floor or the destination floor from a user device; and
means for issuing a command to close doors at the departure floor or the destination floor in response to the door closing command.

17. An elevator system comprising the system of claim 9.

18. A computer program comprising instructions stored thereon for performing the method of claim 1.

19. A computer-readable medium comprising a computer program comprising instructions stored thereon for performing the method of claim 1.

20. The method according to claim 2, further comprising:
obtaining schedule information relating to the at least one transportable entity associated with the hauling call; and
generating the hauling call based on the schedule information.
